(19) United States
(12) Patent Application Publication
(10) Pub. No.: US 2010/0149522 A1
(43) Pub. Date: Jun. 17, 2010

(54) METHOD FOR SIMULATING THE TRANSMISSION CHARACTERISTICS OF OPTICAL MULTIMODE WAVEGUIDES

(75) Inventors: Thomas Bierhoff, Volkmarsen (DE); Hans-Jürgen Schrage, Lippstadt (DE); Oliver Stübbe, Beverungen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/667,296

(22) PCT Filed: Jun. 25, 2008
(86) PCT No.: PCT/EP08/58052

§ 371 Date: Feb. 1, 2010

(30) Foreign Application Priority Data
Jul. 6, 2007 (DE) 10 2007 031 681.1

(51) Int. Cl. G01N 21/00

(52) U.S. Cl. 356/73.1

(57) ABSTRACT

A method for determining optical characteristics of a channel waveguide by way of beam tracking by calculating a profile of sample beams using geometrical optics, in which first the profile is determined as a curve by projection into a two-dimensional area, then a three-dimensional area is determined by the curve, in which area the three-dimensional profile is determined as a substantially two-dimensional problem. A device or installation and a software product which use the method are also provided.

The invention relates to determining transmission characteristics of multimode extruded optical waveguides by way of beam tracking (ray tracing).

To calculate the beam propagation in dielectric channel waveguides, in particular light guides, wave-optical analysis methods such as the method of finite elements (FEM) or the ‘Beam Propagation Method’ (BPM) were previously available. However these can then only be used efficiently if only one or a few modes are to be considered and the cross-section of the waveguides, in respect of the optical wave length, is not too large.

By contrast, beam trackings based on geometric optics are efficiently possible for multimodal step index or gradient index waveguides, in which the cross-section is substantially larger than the wavelength of the radiation used.

A plurality of beams is (in the simulation) injected here into the waveguide in a predetermined direction and polarization. This either takes place at the end of the waveguide or is interrupted at a wall of the optical channel, i.e. the boundary area of the index increment. These methods are specified for instance in the publication by Th. Bierhoff, A. Himmler, E. Griese and G. Mrozynski, “3D-rendering technique to model arbitrary shaped board integrated optical step index waveguides using cubic spline interpolation”, Proceedings of 5^{th} International IEEE Workshop on Signal Propagation on Interconnects (SPI'01), Venice (Italy). Detailed representations can also be found in the dissertation by Th. Bierhoff, “Strahlenoptische Analyse der Wellenausbreitung und Modenkopplung in optisch hoch multimodalen Wellenleitern” [Beam-optical analysis of the wave propagation and mode coupling in optically high multimodal waveguides], Shaker publishing company 2006, ISBN 3-8322-5801-9.

The efficient calculation of such beam profiles is needed for the production of development tools, with which the development engineer is able to monitor a project by way of simulation and compare a test piece with the simulation using the facility specified in DE 199 48 378 C1.

The publication DE 103 34 107 A1 specifies an improved method compared with the afore-cited publication, said method enabling beam tracking in continuous multimodular channel waveguides by overlaying analytically describable partial pieces. This method is advantageous in that the very complex three-dimensional structure, as occur at the coupling point of optical guides, can be calculated efficiently. Nevertheless, practice has shown that the calculation for optical waveguides embedded in conductor boards for instance, which are mostly very long proportionately to thickness, is also not possible in an adequately efficient fashion.

The article by D. Israel, R. Baets, M. J. Goodwin, et.al., “Multimode polymeric Y junctions for star couplers in back-plane optical interconnect”, Applied Optics, Vol. 36 No. 21, Jul. 20, 1997 uses beam tracking to determine the performance data of Y junctions. A 2D calculation is used here for approximation.

The object of the invention is to improve efficiency and accuracy when determining the transmission in optical waveguides of the said type, in particular for complex structures such as junctions and reflectors.

The invention achieves this object for waveguides with a rectangular cross-section. With this type of problem, the waveguide can be regarded as a linear extrusion of a base area. The knowledge is utilized such that in this case the projection of each test beam on the base area equates to the profile which, as a two-dimensional problem, listens the reflection rules. The outlay can thus be substantially simplified by the beam profile being calculated for the two-dimensional case in a first step and then being extended to the three-dimensional case. This occurs by a traverse being determined from the enriched projected profile in the first step, said traverse, when folded out, once again representing a two-dimensional channel in which the reflection can be more easily calculated than in the three-dimensional case. In simple cases, only the length of the sample beam and the exit direction is needed (and/or loss due to a total reflection not carried out); in this case the three-dimensional beam profile does not need to be calculated explicitly. Since not only the path length but also the number of reflections are already present at the same time, a weakening can also be considered by way of an incomplete total reflection.

The invention is described on the basis of an exemplary embodiment, in which;

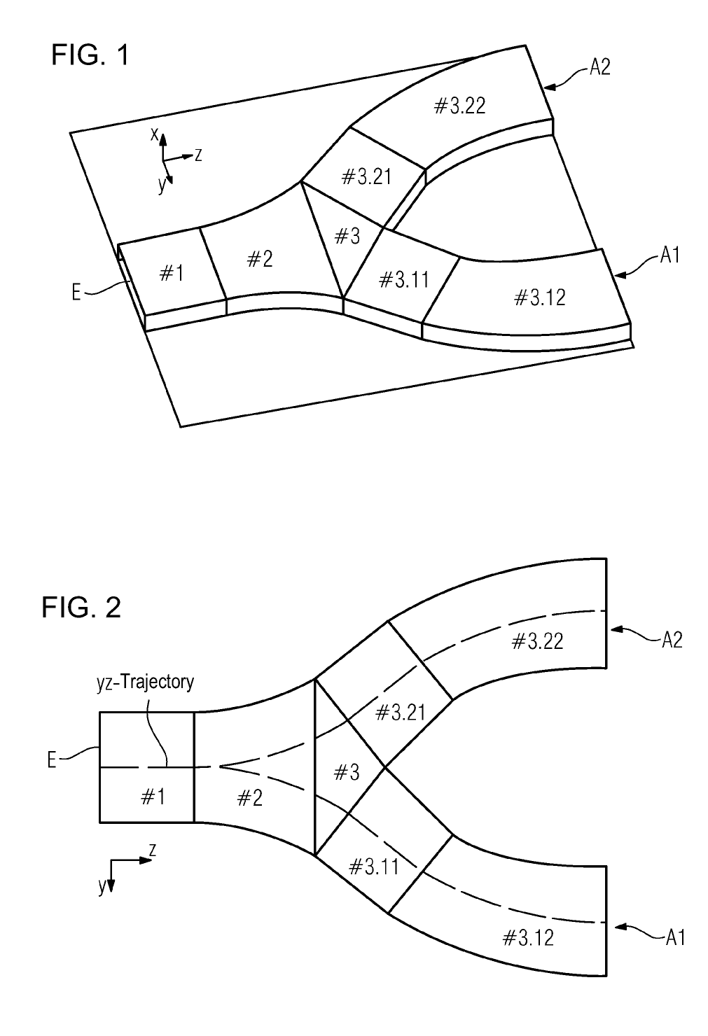

FIG. 1 shows the spatial view of an exemplary channel waveguide,

FIG. 2 shows the projections in the so-called base plane,

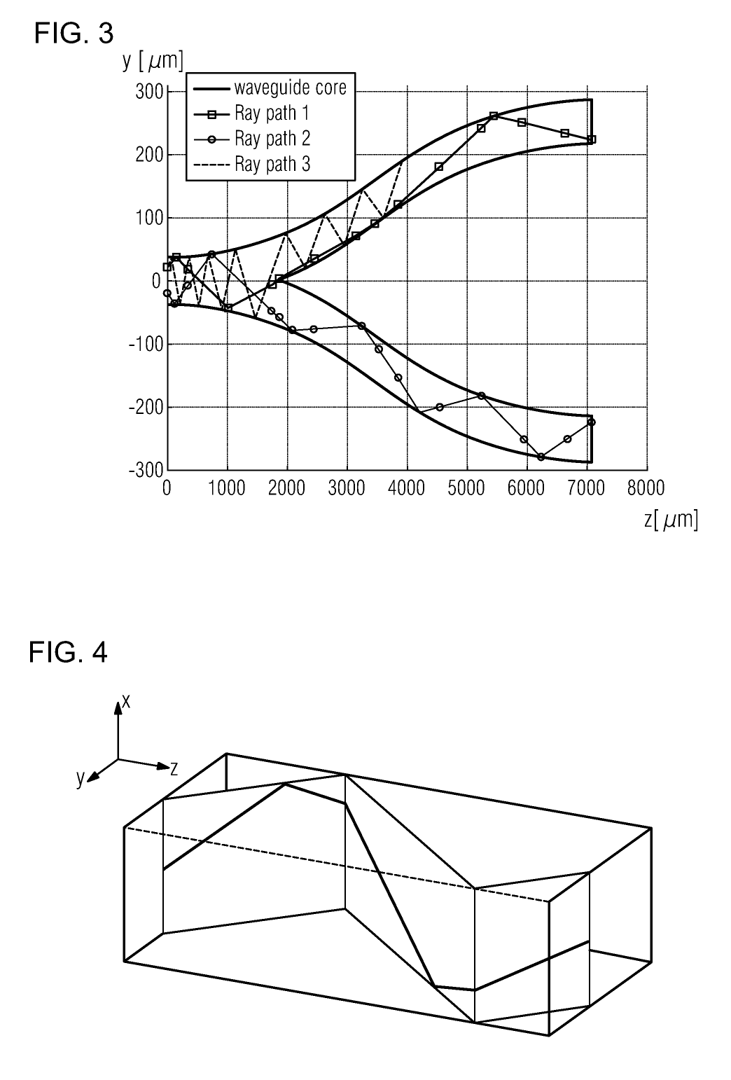

FIG. 3 shows three different beam profiles calculated in the base plane,

FIG. 4 shows an example of a traverse appearing in the base plane after calculation,

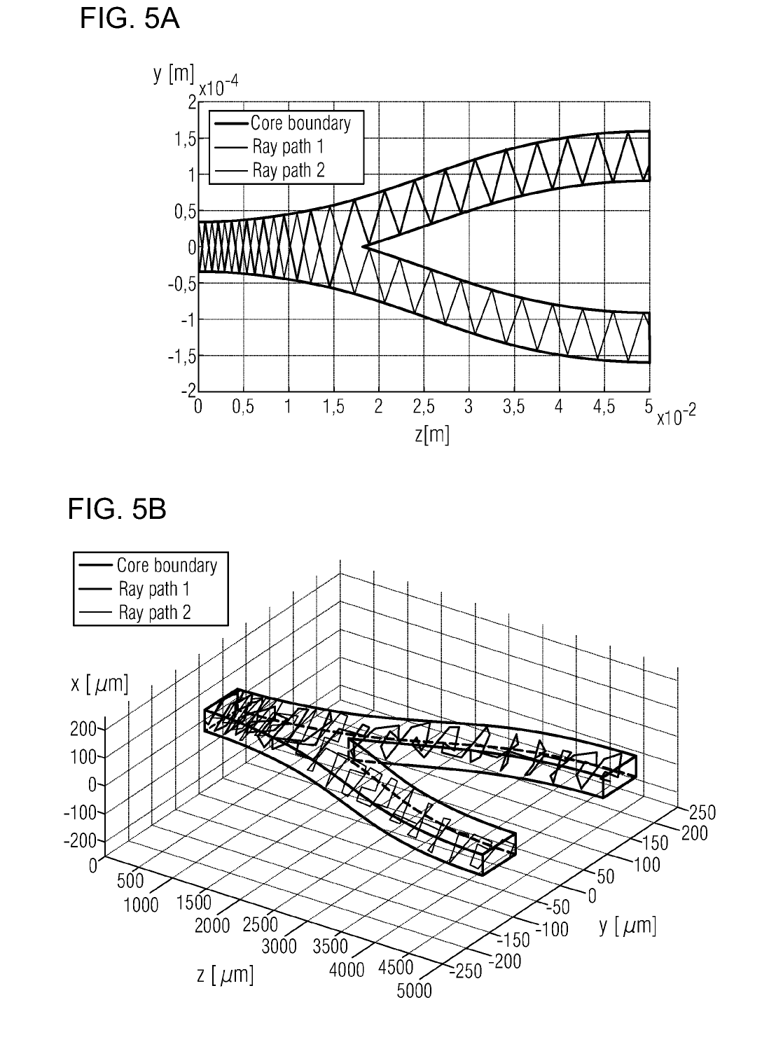

FIGS. 5a and 5b show calculated exemplary beam profiles, in the base plane and in the 3D room.

A channel waveguide is outlined spatially by way of example in FIG. 1, on the basis of which the following description of an embodiment of the invention is illustrated. This concerns an already relatively complex structure which is not only partially edged with curved areas, but instead also contains a waveguide division. For the determination of the transmission behavior, the area of the segment #1 disposed in the left of the image is used in the x-y plane and referred to with E and in accordance with the exit, the two right areas of segment #3.22 and 3.12 in the x-y plane are referred to with A1 and A2. The remaining areas are assumed to be lateral faces, which effect total reflection by way of an index increment, provided the angle of incidence is sufficiently flat. The channel waveguide can be regarded as having been created by means of extrusion along the x-axis.

FIG. 2 shows the projection of the channel waveguide in the y-z plane. This two-dimensional area is referred to below as a base area, the extrusion of which in the x-direction produces the channel waveguide. A y-z trajectory is also shown here by means of dashes, which indicates the macroscopic profile of the channel waveguide. The engineer at the workstation will generally predetermine the nominal width and height and thus the cross-section (x-y plane), as well as the profile as the trajectory, along which the cross-section is to be extruded. If junctions are needed inter alia, the channel waveguide is if necessary thought to be combined from suitable segments. This is the usual representation, which is shown in FIG. 1 for a better overview. To apply the invention, only the edges of the base area are of importance. These are calculated from the trajectory, which is given as the combined curve of linear elements, by way of displacement about the half width in the y-direction and determining the intersection points respectively.

Once the base area is determined, the projection in the plane of the base area is determined for a sample beam, which strikes the entrance area, so that this strikes the linear edge E of the base area. After the corresponding refraction on the media transition of the entrance area, a beam appears, the profile of which is calculated according to the rules of the geometric optics, as shown in image 3 for three examples (marking the polylines for clarification). Depending on the angle and position of incidence, an incident beam either reaches the first exit A1 or the second exit A2 or gets lost (beam 3), because the angle of impact on the wall is not sufficient for total reflection. The latter determines the maximum entrance angle, according to which a transmitter can be determined, so that as few losses as possible occur.

Because the projection of the three-dimensional profile of a sample beam is no longer determined in the base area, this polyline is extruded in the same fashion as the base area. This is shown in FIG. 4, with, for the sake of improved clarify, only a section being shown without reference to FIG. 3. As the polyline consists of a sequence of straight segments, the extrusion is a polygon sequence, i.e. a sequence of rectangles, which are each connected to one another by way of a shared edge. Since the extrusion took place at right angles to the base plane, the edges are at right angles to the base plane. The profile per rectangle can thus be calculated and during transition from one to the next rectangle, the impact angle can be adopted as an angle of incidence.

Since the polygon sequence is however pulled apart in a manner similar to a fanfold paper and can be transformed into a single rectangle, it is possible to reachieve the beam profile as a simple two-dimensional object. To this end, only the length of the polyline has to be determined in the base plane. To further determine the beam profile, a single rectangle is then used at the height of the waveguide and the calculated length of the sample beam. The start angle is calculated from the projection of the incident beam on the first rectangle of the traverse, said start angle determining the further profile.

FIG. 5a shows two other sample beams, the profile of which was calculated in the base plane. The corresponding spatial profile is shown in FIG. 5b, as a result of the slightly different beam lengths, different profiles result in the 3D room despite similar profiles in the base plane. Nevertheless, the 3D profile is generally not needed, but instead only the impact angle and if necessary the number of reflections, which is the sum of the reflections in the base area and the rectangle which corresponds to the extruded traverse. The path which determines the runtime and thus the phase relationship is identical to the path on the rectangle corresponding to the traverse and can thus be accurately determined in the 3D space without calculations; no approximations are used here. The present method represents a substantial acceleration of the simulation even if the 3D profile is needed.

1-6. (canceled)

7. A method for determining optical characteristics of a channel waveguide, the method comprising the following steps:
beam tracking by calculating a profile of sample beams using geometrical optics;
initially determining the profile as a curve by projection into a two-dimensional area; and
then determining a three-dimensional area with the curve by determining a three-dimensional profile in the three-dimensional area as a substantially two-dimensional problem.

8. The method according to claim 7, which further comprises:
representing the channel waveguide by extrusion of a base area along a straight line, by:
projecting an incident beam into a plane of the base area and determining the profile of the sample beam there as a polyline in the base area;
determining a traverse of squared areas from the polyline by extrusion, with the areas forming a sequence by shared edges, starting with an entrance area and ending in an exit area; and
determining the profile of the sample beam in each instance within the areas and on the shared edges.

9. The method according to claim 7, which further comprises:
placing a straight line of an extrusion at right angles on a base area, by:
projecting a beam, appearing after refraction on an entrance area of the channel waveguide, onto the entrance area toward an incident beam;
during a transition between a first and a second area of a traverse with a shared edge, using an angle of impact on the edge as an angle of entrance for a second polygon and determining the profile within the second area; and
determining a beam leaving the exit area as an outgoing beam with respect to an exit area.

10. The method according to claim 9, which further comprises calculating reflections in a two-dimensional rectangular waveguide instead of directly in the traverse, having a height being that of the waveguide and a width being a length of a polyline determined in a base plane.

11. A device for evaluating a transmission behavior of channel waveguides with a rectangular cross-section by simulation, the device comprising:
an apparatus for carrying out the method according to claim 7.

12. A computer software product stored on a memory executable by a processor to perform the steps of the method according to claim 7 for evaluating a transmission behavior of channel waveguides with a rectangular cross-section by simulation.
